(19) United States
(12) Patent Application Publication
(10) Pub. No.: US 2009/0235039 A1
(43) Pub. Date: Sep. 17, 2009

(54) Digital Data Reproducing Apparatus

(75) Inventors: Akira Hashimoto, Gunma-ken (JP); Masatoshi Sato, Ota-shi (JP)

Correspondence Address: SoCAL IP LAW GROUP LLP, 310 N. WESTLAKE BLVD. STE 120, WESTLAKE VILLAGE, CA, 91362, US

(73) Assignees: Sanyo Electric Co., Ltd., Osaka (JP); Sanyo Semiconductor Co., Ltd, Ora-gun (JP)

(21) Appl. No.: 12/402,391

(22) Filed: Mar. 11, 2009

(30) Foreign Application Priority Data
Mar. 13, 2008 (JP) 2008-064674

(51) Int. Cl. G06F 12/02

(52) U.S. Cl. 711/165; 711/E12.002

(57) ABSTRACT

A digital data reproducing apparatus comprising: a reproducing unit configured to reproduce input digital data; an encoding unit configured to store encoded data obtained by encoding the digital data into a memory; a transferring unit configured to transfer the encoded data stored after a transfer address specified in the memory to an encoded data reproducing apparatus capable of reproducing the encoded data; and a control unit configured to specifies the transfer address in the transferring unit in accordance with a transfer instruction signal giving an instruction for transfer of the encoded data corresponding to the digital data already reproduced.

### CROSS-REFERENCE TO RELATED APPLICATION

This application claims the benefit of priority to Japanese Patent Application No. 2008-64674, filed Mar. 13, 2008, of which full contents are incorporated herein by reference.

### BACKGROUND OF THE INVENTION

1. Field of the Invention

The present invention relates to a digital data reproducing apparatus.

2. Description of the Related Art

Audio and video digital data stored in a recording medium such as CD (Compact Disc) is converted into encoded data in the MP3 (MPEG Audio Layer-3) format, etc., and transferred to an encoded data reproducing apparatus such as a portable player through USB (universal Serial Bus), etc., in some cases. Such encoding of digital data for transfer to the external memory such as compression is called ripping. The ripping is performed not only for digital data stored in a recording medium such as CD but also for analog signals output from a tuner of a radio or analog signals input from the outside through a connection terminal, etc., (see, e.g., Japanese Patent Application Laid-Open Publication No. 2007-133955).

For example, while listening to reproduction of radio broadcast without ripping, one may want to start the ripping in the middle, when a song of a favorite singer begins. In such a case, since the instruction of the ripping is given at this point, a portion already reproduced cannot be ripped. The encoded data corresponding to the digital data already reproduced at the time of giving the instruction of the ripping cannot be transferred to the encoded data reproducing apparatus such as a portable player.

### SUMMARY OF THE INVENTION

A digital data reproducing apparatus according to an aspect of the present invention, comprises: a reproducing unit configured to reproduce input digital data; an encoding unit configured to store encoded data obtained by encoding the digital data into a memory; a transferring unit configured to transfer the encoded data stored after a transfer address specified in the memory to an encoded data reproducing apparatus capable of reproducing the encoded data; and a control unit configured to specifies the transfer address in the transferring unit in accordance with a transfer instruction signal giving an instruction for transfer of the encoded data corresponding to the digital data already reproduced.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram of a configuration of a digital data reproducing apparatus that is one embodiment of the present invention; and

FIG. 2 is a flowchart of an example of a process when an instruction is given to retrospectively transfer MP3 data to a USB device 42.

### DETAILED DESCRIPTION OF THE INVENTION

At least the following details will become apparent from descriptions of this specification and of the accompanying drawings.

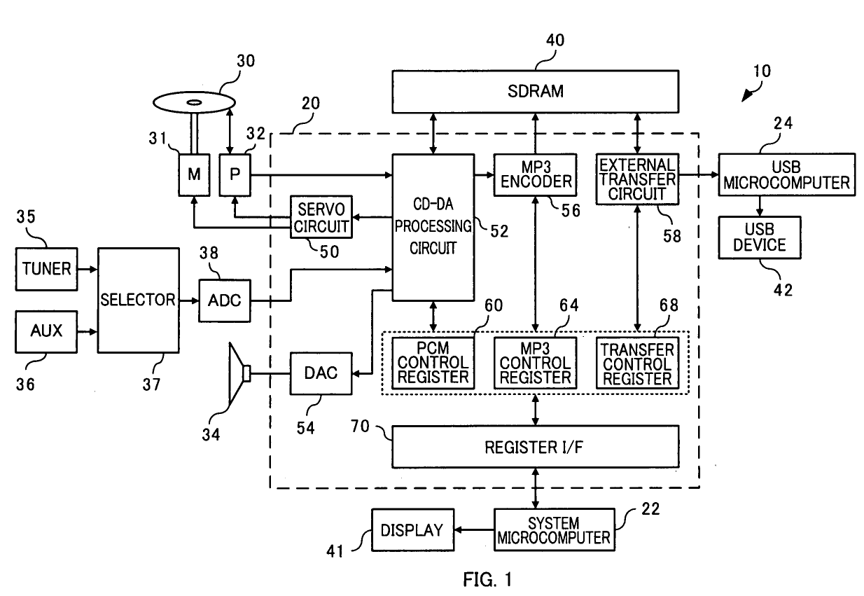

FIG. 1 is a diagram of a configuration of a digital data reproducing apparatus that is one embodiment of the present invention. A digital data reproducing apparatus 10 includes a DSP (Digital Signal Processor) 20, a system microcomputer 22, and a USB (Universal Serial Bus) microcomputer 24.

The DSP 20 rotates a CD-standard recording medium 30 with a spindle motor 31, reads digital data (PCM (pulse Code Modulation) data) in the PCM format with a laser beam output from a pickup 32, and reproduces the read PCM data to output audio from a speaker 34 based on the control of the system microcomputer 22. Analog signals output from a tuner 35 for radio broadcast and analog signals output from an external input terminal (AUX) 36 are selected by a selector 37, converted by an ADC (Analog to Digital Converter) 38 into, for example, PCM data, and input to the DSP 20. The DSP 20 reproduces the PCM data input from the ADC 38 to output audio from the speaker 34. The DSP 20 generates encoded data (MP3 data) obtained by encoding the PCM data from the recording medium 30, the tuner 35, and the external input terminal 36 into the MP3 format and stores the encoded data into SDRAM (Synchronous Dynamic Random Access Memory) 40 based on the control of the system microcomputer 22. The DSP 20 sequentially outputs pieces of the MP3 data stored in the SDRAM 40 through the USB microcomputer 24 to a USB device 42 that is an encoded data reproducing apparatus capable of reproducing MP3 data based on the control of the system microcomputer 22. The format conversion for transferring digital data stored in a recording medium or input from a tuner, etc., to an external memory such as a portable player is called ripping. A process of converting PCM data from the recording medium 30, the tuner 35, and the external input terminal 36 into MP3 data is the ripping in this embodiment.

The system microcomputer 22 (control unit) accepts instructions for reproducing the PCM data stored in the recording medium 30, selecting a channel of the tuner 35, selecting an input source, executing the ripping, transferring the MP3 data to the USB device 42, etc., from a user to transmit data to and receive data from the DSP 20, etc., depending on the instructions. The system microcomputer 22 may output various pieces of information associated with the reproduction of the PCM data, the ripping, etc., to a display 41. For example, when a certain tune is reproduced, reproduction instruction data specifying the track number of the tune are transmitted to the DSP 20. Control data about reproduction time, etc., are transmitted from the DSP 20 to the system microcomputer 22, and information obtained from the control data is displayed on the display 41. Alternatively, for example, when the PCM data from the tuner 35 is ripped during reproduction and transferred to the USB device, the transfer instruction data for the MP3 data is transmitted to the DSP 20 along with the reproduction instruction data for the PCM data output from the ADC 38. Alternatively, for example, in the case where the transfer of the MP3 data to the USB device 42 is started retrospectively from the past time in which the reproduction had already been performed in the middle of the reproduction of the PCM data from the tuner 35, a read address corresponding to the retrospective time is transmitted from the SDRAM 40 to the DSP 20.

The USB microcomputer 24 is a processing circuit for transferring the data output from the DSP 20 to a USB device 42 such as a portable music player having a memory connected through a USB connector. For example, pieces of the MP3 data generated by the ripping are sequentially output to the USB microcomputer 24 at a speed in accordance with the specifications of the USB microcomputer 24 and the USB device 42 and are transferred to the USB device 42.

Although the recording medium 30 conforms to the CD standard in this embodiment, the standard of the recording medium 30 is not limited to CD and may be any standards, for example, DVD (Digital Versatile Disc), as long as the stored digital data may be ripped. The digital data to be ripped is not limited to PCM data and the data generated by the ripping is not limited to MP3 data. For example, digital data in the DVD-Video format may be ripped to generate digital data in the MPEG format. The standard for transferring the digital data generated by the ripping to an external portable music player, etc., is not limited to USB.

A detailed configuration of the DSP 20 will be described. The DSP 20 includes a servo circuit 50, a CD-DA (Compact Disc Digital Audio) processing circuit 52, a DAC (Digital to Analog Converter) 54, an MP3 encoder 56, an external transfer circuit 58, a PCM control register 60, an MP3 control register 64, a transfer control register 68, and a register I/F (Interface) 70.

The servo circuit 50 controls the spindle motor 31 to adjust the readout speed of the PCM data stored in the recording medium 30. The servo circuit 50 controls the pickup 32 such that the laser beam output from the pickup 32 is applied to a proper position.

The CD-DA processing circuit 52 (reproducing unit) outputs control data for reading desired PCM data stored in the recording medium 30 to the servo circuit 50 based on the information set in the PCM control register 60 through the register I/F 70 if the PCM data stored in the recording medium 30 is reproduced. The CD-DA processing circuit 52 converts RF (Radio Frequency) signals output from the pickup 32 into digital signals to generate PCM data. If the analog signals from the tuner 35 or the external input terminal 36 are reproduced, the PCM data obtained by the digital conversion of the analog signals is input from the ADC 38 to the CD-DA processing circuit 52. The PCM data from the recording medium 30, the tuner 35, and the external input terminal 36 is converted by the DAC 54 into the analog signals to be audio-output from the speaker 34. The PCM data from the recording medium 30, the tuner 35, and the external input terminal 36 is also output to the MP3 encoder 56. The CD-DA processing circuit 52 outputs control data for performing the focus control and the tracking control of the pickup 32 based on the RF signals from the pickup 32.

The MP3 encoder 56 (encoding unit) encodes (compresses) the PCM data output from the CD-DA processing circuit 52 to generate MP3 data based on the information set in the MP3 control register 64 through the register I/F 70, and store the generated MP3 data into the SDRAM 40. It is assumed in this embodiment that the information is set in the MP3 control register 64 such that the PCM data output from the CD-DA processing circuit 52 is always converted into MP3 data to be stored in the SDRAM 40 regardless of the presence of the instruction for transfer to the USB device 42. The MP3 encoder 56 stores the MP3 data into a predetermined area of the SDRAM 40 in a cyclic manner. The area storing the MP3 data is managed as a ring buffer and if pieces of the MP3 data are continuously generated without transferring to the USB device 42, the pieces of MP3 data are sequentially overwritten in order of occurrence. Therefore, if the MP3 data is not transferred to the USB device 42, the SDRAM 40 accumulates the MP3 data generated by encoding the reproduced PCM data. For example, assuming that a size of the area of the SDRAM 40 storing the MP3 data is 64 Mbit and that the bit rate of the MP3 data is 96 kbps (Kilobit per second), the SDRAM 40 may accumulate the MP3 data of the past about 11 minutes. The MP3 encoder 56 stores information about the write address of the MP3 data to the SDRAM 40 and the number of data (number of words) of the MP3 data stored in the SDRAM 40 and not transferred.

The external transfer circuit 58 (transferring unit) reads the MP3 data stored in the SDRAM 40 and outputs the data to the USB microcomputer 24 based on information such as the MP3 data transfer address set in the transfer control register 68 through the register I/F 70. The MP3 data output to the USB microcomputer 24 is transferred to the USB device 40 such as a portable player. The external transfer circuit 58 may read the MP3 data stored at the read address set in the transfer control register 68 from the SDRAM 40 to store the data in the transfer control register 68.

The digital data reproducing apparatus 10 may perform the ripping while reproducing the PCM data from the recording medium 30, the tuner 35, and the external input terminal 36 and may transfer the MP3 data generated by the ripping to the USB device 42 as above. Since the digital data reproducing apparatus 10 rips and stores the reproduced PCM data into the SDRAM 40 regardless of the presence of the instruction for transfer to the USB device 42, the MP3 data may be transferred retrospectively from the past time if the instruction for transfer to the USB device 42 is made in the middle of the reproduction of the PCM data without transferring to the USB device 42.

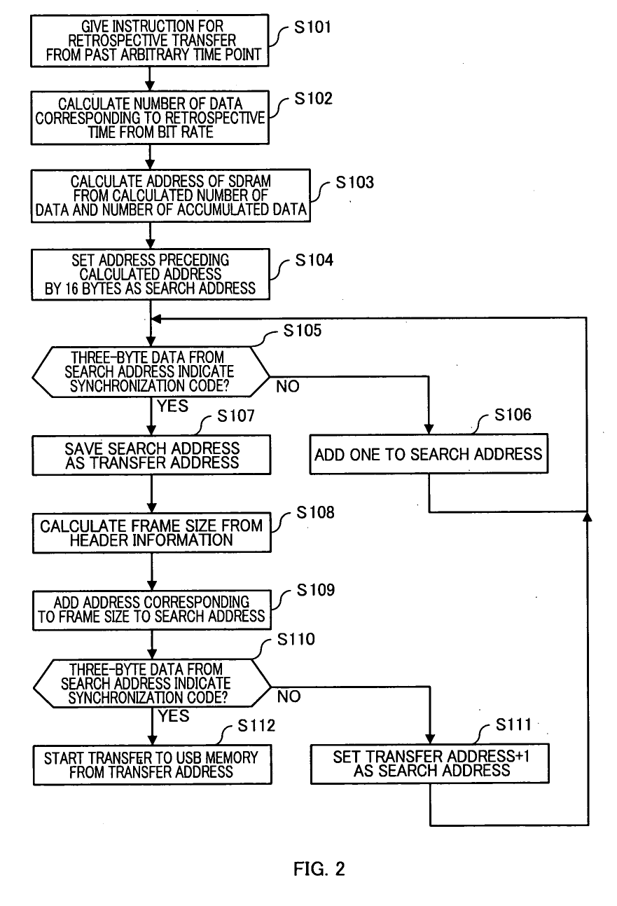

FIG. 2 is a flowchart of an example of a process when an instruction is given to retrospectively transfer MP3 data to a USB device 42. It is assumed that the PCM data from the tuner 35 is reproduced without the instruction for transfer to the USB device 42 in the initial state and that the MP3 data generated by encoding the reproduced PCM data is stored in the predetermined area of the SDRAM 40 in a cyclic manner.

It is assumed that a user wants to transfer the part already reproduced to the USB device 42 when the PCM data is reproduced without transferring to the USB device 42. In this case, an instruction (transfer instruction signal) for transferring the MP3 data ripped and stored in the SDRAM 40 to the USB device 40 retrospectively from a past arbitrarily time point, is input by a user (S101). The system microcomputer 22 calculates the number of data (number of words) to be transferred corresponding to the retrospective time based on the bit rate of the MP3 data based on the retrospective time information included in the transfer instruction from the user (S102). The retrospective time may preliminarily be determined instead of input from the user. All the MP3 data stored in the SDRAM 40 and not transferred may be data to be transferred without specifying the retrospective time.

The system microcomputer 22 calculates an address specifying the start position of the transfer based on the calculated number of data, the number of data (number of words) of the MP3 data accumulated in the SDRAM 40 and not transferred, and the information indicative of the write address, for which the MP3 control register 64 is set (S103). The system microcomputer 22 sets an address preceding the calculated address by, for example, 16 bytes, as a search address for searching a delimiter of frames making up the MP3 data (S104).

The system microcomputer 22 checks whether three-byte data from the search address of the SDRAM 40 indicate a synchronization code (0xFFF) corresponding to delimiter data indicative of the beginning of the frame (S105). Specifically, information giving an instruction for reading data stored at the search address is set in the transfer control register 68 and the data read from the search address is stored in the transfer control register 68. The system microcomputer 22 refers to the data stored in the transfer control register 68 to check whether the three-byte data from the search address indicate the synchronization code.

Until the three-byte data from the search address indicate the synchronization code (S105: NO), the system microcomputer 22 increments the search address by one at a time (S106). If the three-byte data from the search address indicate the synchronization code (S105: YES), the system microcomputer 22 retains the search address as a transfer address (S107). The system microcomputer 22 extracts header information of the MP3 data frame from the data read from the transfer address and calculates the frame size based on the header information (S108). Specifically, assuming that the number of samplings per frame is 144, the frame size may be obtained on the basis of a bit rate, a sampling frequency, and a padding bit (0 or 1) included in the header information by calculation using the formula, (the frame size)=144×(bit rate)/(sampling frequency)+(padding bit).

After the frame size is calculated, the system microcomputer 22 adds an address corresponding to the frame size to the search address (S109) and checks whether the three-byte data from the search address of the SDRAM 40 indicate the synchronization code (S110). If the three-byte data from the search address do not indicate the synchronization code (S110: NO), the system microcomputer 22 determines that the transfer address is not the address indicative of the beginning of the frame, sets an address obtained by adding one to the transfer address as the search address (S111), and goes back to the process of searching from the search address (S105). If the three-byte data from the search address indicate the synchronization code (S110: YES), the system microcomputer 22 determines that the transfer address is the address indicative of the beginning of the frame, and sets the transfer control register 68 for information for controlling the external transfer circuit 58 so as to transfer the MP3 data after the transfer address to the USB device 42 through the USB microcomputer 24 (S112). This starts the transfer of the MP3 data to the USB device 42 retrospectively from the past reproduction time. Since pieces of the MP3 data are stored in the SDRAM 40 in the cyclic manner, the MP3 data after the transfer address may include MP3 data stored at an address smaller than the transfer address.

The digital data reproducing apparatus 10 may transfer MP3 data to the USB device 42 retrospectively from the past reproduction time if a user wants to transfer the portion already reproduced to the USB device 42 while the PCM data is reproduced without transferring to the USB device 42.

The digital data reproducing apparatus 10 may control the retrospective time in accordance with the specification from a user. Therefore, only the portion necessary for the user may be transferred to the USB device 42 in the MP3 data corresponding to the PCM data already reproduced.

The digital data reproducing apparatus 10 sets the search address as the transfer address if the synchronization code of frames making up the MP3 data is stored at the search address calculated based on the retrospective time. Therefore, the MP3 data may be transferred to the USB device 42 for each frame.

The digital data reproducing apparatus 10 determines that the transfer address is located at the beginning position of the frame if the synchronization code of the frame is stored at the address obtained by adding the frame size of the MP3 data to the transfer address. Therefore, the erroneous determination of the beginning position of the frame may be prevented.

As above, according to the embodiment, the encoded data obtained by ripping digital data may be transferred to an encoded data reproducing apparatus retrospectively from the past reproduction time.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. A digital data reproducing apparatus comprising:
a reproducing unit configured to reproduce input digital data;
an encoding unit configured to store encoded data obtained by encoding the digital data into a memory;
a transferring unit configured to transfer the encoded data stored after a transfer address specified in the memory to an encoded data reproducing apparatus capable of reproducing the encoded data; and
a control unit configured to specify the transfer address in the transferring unit in accordance with a transfer instruction signal giving an instruction for transfer of the encoded data corresponding to the digital data already reproduced.

2. The digital data reproducing apparatus of claim 1, wherein
the transfer instruction signal includes retrospective time information indicative of a retrospective time as data to be transferred in the encoded data corresponding to the digital data already reproduced, and wherein
the control unit specifies the transfer address based on a bit rate of the encoded data and the retrospective time information.

3. The digital data reproducing apparatus of claim 1, wherein
the control unit specifies as the transfer address an address at which delimiter data indicative of a beginning of a frame making up the encoded data is stored.

4. The digital data reproducing apparatus of claim 3, wherein
when the delimiter data is stored at an address obtained by adding an address corresponding to a size of the frame to the address at which the delimiter data is stored, the control unit specifies as the transfer address the obtained address at which the delimiter data is stored.
